(19) United States
(12) Patent Application Publication
(10) Pub. No.: US 2006/0170905 A1
(43) Pub. Date: Aug. 3, 2006

(54) Common carrier for loading capillary vessels

(76) Inventor: George Paul Tsai, San Jose, CA (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 11/049,210

(22) Filed: Feb. 2, 2005

(51) Int. Cl. G01N 1/10

(52) U.S. Cl. 356/36; 436/180

(57) ABSTRACT

A method of loading a fluid sample into a capillary vessel, the method comprising: attaching one or more capillary vessels to a common carrier, each capillary vessel having an opening and an interior volume sized for loading the capillary vessel by capillary action; positioning the common carrier so that the capillary vessel openings face downward; and positioning the capillary vessel openings into contact with a fluid in a reservoir.

### BACKGROUND

When performing analytical procedures, it is often desirable to verify the quality of the sample that is being analyzed or otherwise processed. When sampling genetic material such as DNA or RNA for example, it is common perform an amplification process on a sample to increase the amount of genetic material. A small microliter portion of the amplified sample is then analyzed using a spectrophotometer to verify the amount or concentration of the genetic material in the sample.

The samples are typically stored in the wells of a microtiter plate, interior volumes of Eppendorf tubes, or some similar laboratory container. Each sample from these laboratory containers is typically analyzed one at a time using a pipette or similar device to transfer a microliter volume of the sample to the analytical instrument or an individual sample holder that is inserted into the analytical instrument for analysis, although an alignment fixture can be used to aid in positioning a pipette at the opening of each corresponding sample holder. There are several problems with these techniques. For example, using pipettes to transfer micoliter volume samples commonly results inconsistent fill levels between vessels. Another problem is that bubbles can be transferred from the pipette tip into the sample holder or Cuvette. These inconsistencies cause undesirable results when the vessel is inserted into an analytical instrument for analysis.

### SUMMARY

In general terms, the present invention relates to simultaneously loading vessels using capillary action.

One aspect of this invention is a method of loading a fluid sample into a capillary vessel. The method comprises attaching one or more capillary vessels to a common carrier, each capillary vessel having an opening and an interior volume sized for loading the capillary vessel by capillary action; positioning the common carrier so that the capillary vessel openings face downward; and positioning the capillary vessel openings into contact with a fluid in a reservoir.

Another aspect of this invention is a method of loading a fluid sample. The method comprises attaching one or more Cuvettes to a common carrier, each Cuvette having an opening and an interior volume sized for loading the Cuvette by capillary action, the interior volume being about 2 μl or less; positioning the common carrier so that the Cuvette openings face downward; positioning the Cuvette openings into contact with a fluid in a reservoir; simultaneously loading fluid into the interior volume of the one or more Cuvettes by capillary action; and loading the common carrier into a spectrophotometer.

### BRIEF DESCRIPTION OF THE DRAWINGS

Further details are explained below with the help of the examples illustrated in the attached drawings in which:

FIG. 1 is an axonometric projection of a common carrier loaded with two Cuvettes.

FIG. 2 is an axonometric projection of the common carrier illustrated in FIG. 1, including three cuvette holder locations, with only one of them being loaded with a cuvette.

FIG. 3 is an axonometric projection of a 96-well plate and the common carrier illustrated in FIG. 1.

FIG. 4 is an axonometric projection of an area of detail of FIG. 3.

FIG. 5 is an axonometric projection of the common carrier illustrated in FIG. 1 and a clamping mechanism latched onto the common carrier.

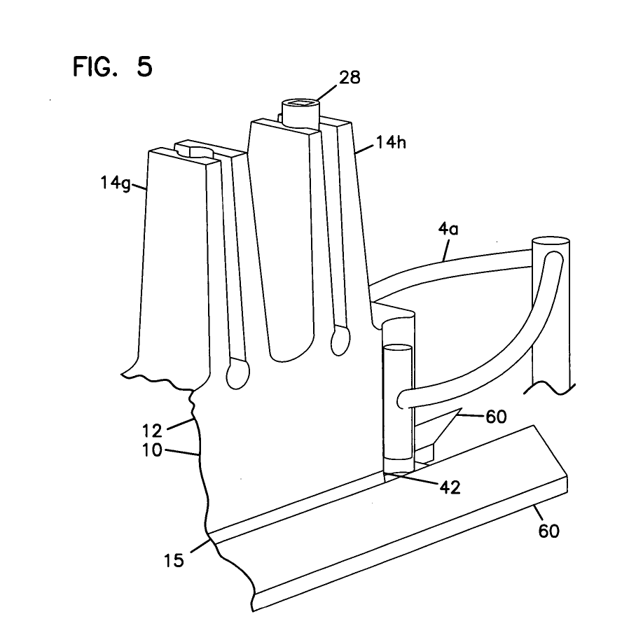

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

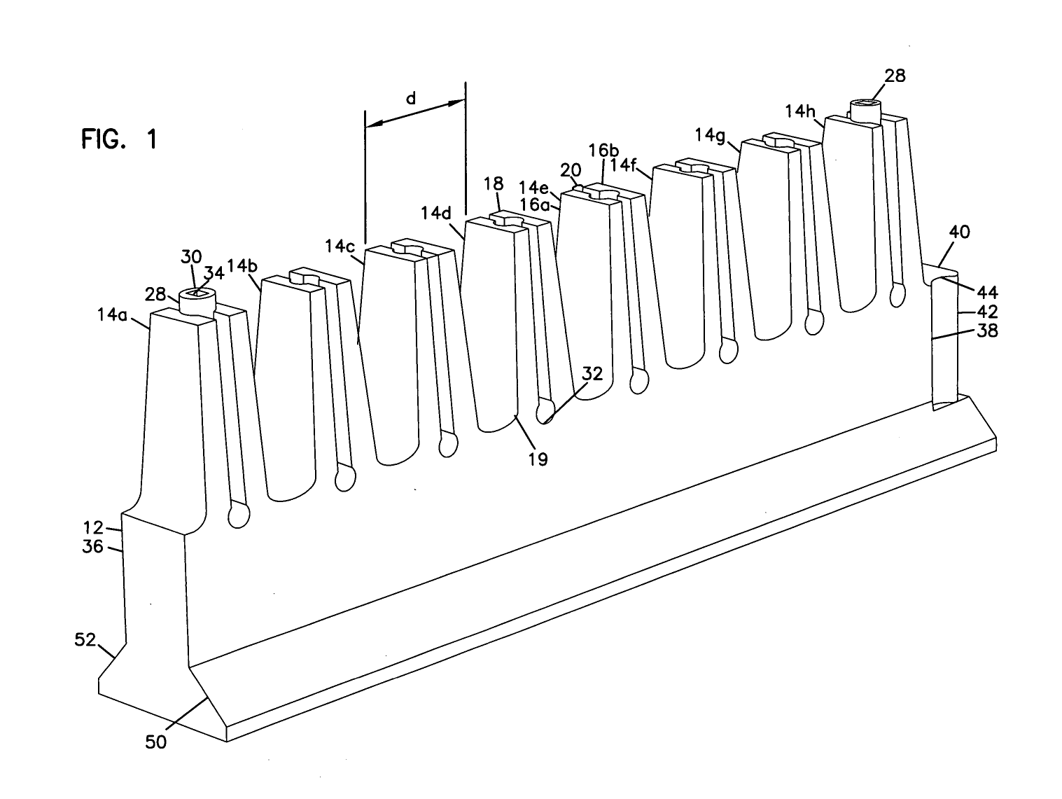

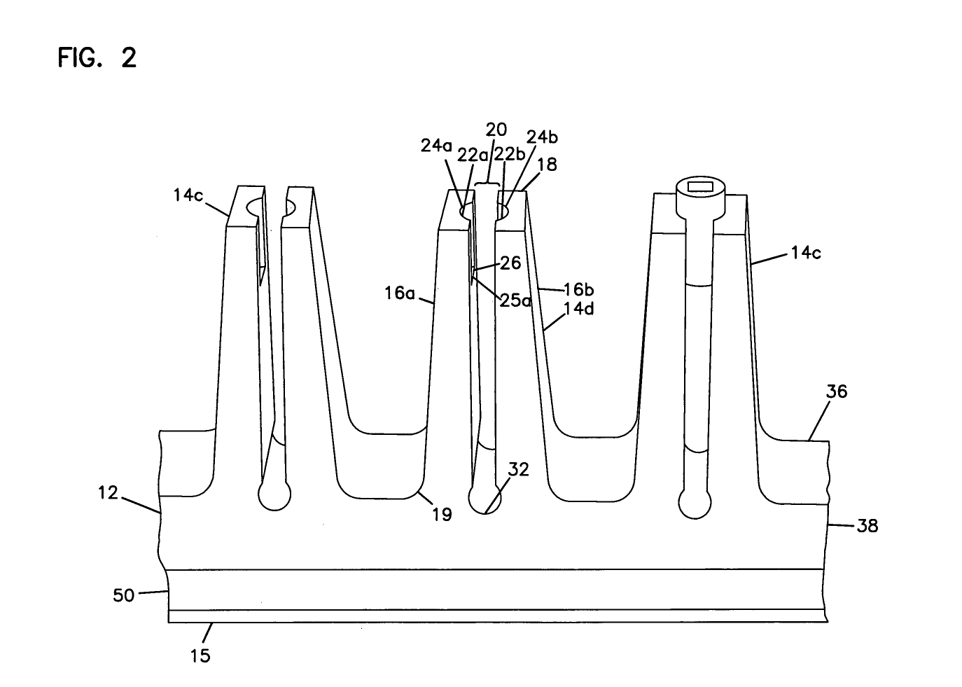

Referring to FIGS. 1 and 2, one possible embodiment of a common carrier 10 that provides a fixture for holding capillary vessels includes an elongated support member 12, eight vessel holders or brackets 14a-14h, and a base 15. The elongated support member 12 has oppositely disposed sides 36 and 38 extending along its length, and has an end portion 40. The brackets 14a-14h are operatively connected to (e.g., either directly or indirectly linked to) and are structured to hold a capillary vessel such as a Cuvette 28 (shown mounted in brackets 14a and 14h in FIG. 1 and in bracket 14c in FIG. 2). Although the exemplary embodiment illustrates Cuvettes 28, other embodiments of the common carrier 10 are configured to hold capillary vessels other than Cuvettes 28.

Bracket 14d has a top edge 18, a bottom portion 19 attached to the elongated support member 12, and two opposing and elongated bracket members 16a and 16b such as fingers, tines, or prongs. The two opposing bracket members 16a and 16b are separated by a gap 20, which provides an aperture for an optical path when the common carrier 10 is used with a spectrophotometer or similar instrument so that light can pass through the Cuvette 28. The width of the gap 20 can vary between embodiments to match the distance between the reservoirs (e.g., wells in a microtiter plate) from which samples are loaded.

Bracket member 16a has a recess 22a formed by a concave surface 24a and a radial surface 25a. The recess 22a opens to the top edge 18 of the bracket 14d and extends toward the bottom portion 19 to the radial surface 25a. The concave surface 24a and the radial surface 25a are substantially orthogonal. Bracket member 14b has a recess 22b substantially similar to and opposing the recess 22a. The recess 22b is formed by a concave surface 24b and a radial surface (not shown). In one possible embodiment, as explained in more detail herein, the shape of the recesses 22a and 22b conform to the outer circumference of the laboratory vessel, which in the exemplary embodiment is a Cuvette 28 (shown mounted in brackets 14a and 14h).

The recesses 22a and 22b form a receptacle for holding the Cuvette 28. Additionally, the radial surface 25a of the elongated bracket member 16a and the radial surface (not shown) of the elongated bracket member 16b form a seat 26 against which the Cuvette 28 is positioned. Additionally, the distance between the seat 26 and the top edge 18 of the bracket 16d is smaller than the height of the Cuvette 28 so that when the Cuvette 28 is positioned against the seat 26, the top edge 30 of the Cuvette 28 extends at least slightly beyond the top edge 18 of the bracket 14d, which assists capillary uptake of the sample. Additionally, the distances from the elongated support member 12 to the seat 26 and from the top edge 18 to the seat 26 are substantially consistent between each of the brackets 14a-14h.

The bottom portion 19 of the bracket 14d defines a break 32 that is open to the gap 20 and extends between the sides 36 and 38 of the elongated support member 12 and has a circular cross-section with a circumference slightly larger than the width of the gap 20. The break provides a relief that makes it easier to spread the bracket members 16a and 16b so that a Cuvette 28 can be mounted in the recesses 22a and 228. An alternative embodiment does not includes the break 32, which makes the common carrier easier to mold when it is formed with a plastic, acrylic, or similar material. In this alternative embodiment the gap 20 terminates at the base portion of the bracket 14d. In another alternative embodiment, the gap 20, with out without a break 32 terminates at a midpoint between the top edge 30 and the bottom portion 19 of the bracket 14d.

The common carrier 10 is formed with a resilient material so that the bracket members 16a and 16b of the bracket 14d can be spread and will naturally return to their original position. In this embodiment, the elongated bracket members 16a and 16b exert a spring force against the side of the Cuvette 28 and hold it in the receptacle formed by the recesses 22a and 22b. In one possible embodiment, the common carrier is a single piece and that is injection molded and formed with polycarbonate, acrylic, polysulphone, or another medical grade material that is resilient.

Brackets 14a-14c and 14e-14h are substantially similar to the bracket 14h. In one possible embodiment, the distance d between adjacent brackets 14 is about 9 mm, which corresponds to a typical distance between wells in the column of a microtiter plate. This spacing allows Cuvettes 28 mounted in the brackets 14a-14h to be simultaneously dipped in the wells of a microtiter plate. In other possible embodiments, the distance d is a distance other then 9 mm and matches the distance between adjacent reservoirs from which samples are loaded into the Cuvettes 28.

In the exemplary embodiment, the Cuvette 28 has an internal cavity 24 with a depth of about 4 mm and cross-sectional dimensions of about 1 mm and about 1 mm to form a capacity volume of about 4 μl. Other embodiments use Cuvettes of different sizes so long as they are capable of being loaded by capillary action. Although a Cuvette of a particular size and structure is illustrated, other embodiments of the common carrier 10 can be used and configured for Cuvettes of other sizes and for other types of vessels that can be loaded with capillary action. For example, an alternative embodiment of a Cuvette has internal dimensions, of about 2 mm by about 1 mm by about 1 mm to form a capacity volume of about 2 μl. The range of dimensions and structures for the laboratory vessel that can be used with the common carrier 10 and still maintain the properties for capillary action depend on the internal dimensions of the laboratory vessel, the type of material that forms the laboratory vessel, and the type of fluid that is being loaded into the laboratory vessel.

When the common carrier is used with a spectrophotometer, one possible embodiment of the Cuvette 28 or other capillary vessel has internal dimensions sized to be about the same size as or only slightly larger than the cross-sectional area of the light beam passed through the Cuvette 28. Any sample loaded in the Cuvette that is not in the path of the light-beam is not analyzed by the spectrophotometer. This embodiment prevents unnecessary waste of the sample from the microtiter plate from which the Cuvette 28 is loaded.

The end 40 of the elongated support member 12 has a grip 42, which is formed with a first grip groove 44 defined in the first side 36 of the elongated support member 12. The first grip groove 44 is linear and extends from and is orthogonal to the base 15. A second grip recess (not shown) that mirrors the first recess 44 is formed on the opposite side 38 of the elongated support member 12. The grip 42 provides a structure by which a clamping mechanism 46 for an automated spectrometer can grip or latch onto the common carrier 10 while the common carrier 10 is indexed through an a spectrophotometer or other analytical instrument for testing samples loaded in the Cuvettes 28. The structure of the grip 42 can vary depending on the clamping mechanism 46 that grips or latches onto the common carrier 10.

Referring back to FIGS. 1 and 2, in one possible embodiment, the base 15 extends along the bottom portion of the elongated support member 12 and has a dovetail cross-section providing a width substantially wider than the elongated support member 12. Sidewalls 50 and 52 slope downward from the sides 36 and 38, respectively, of the elongated support member 12 to the bottom portion of the base 15. The base 15 provides a structure that stabilizes the common carrier 10 when it is set on a lab bench or tabletop. It also provides a structure that a user can grab when loading the Cuvettes 28 as described herein.

In one possible embodiment, the base 15 is configured to be slidably inserted into a track or guide 62 that and retains the common carrier in the automated spectrophotometer. The track 62 positions the common carrier in the automated spectrophotometer. In yet another possible embodiment, the base 15 includes indicia (not shown) indicating the location of each bracket on the common carrier 10. Each of the indicia is a distinctive machine-readable marking that provides a positioning guide to locate and orient the Cuvettes 28 in the automated spectrophotometer. The automated spectrophotometer indexes the common carrier 10 by translating the clamping mechanism 46 to the correct position so that the desired Cuvette 28 within the optical path of the automated spectrophotometer.

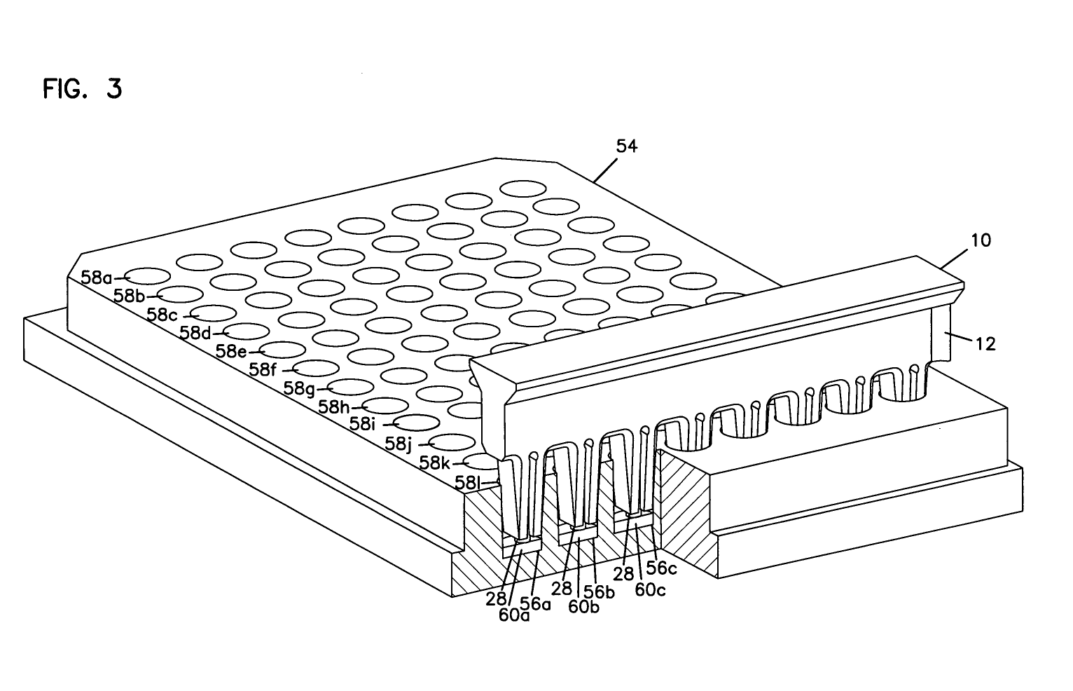

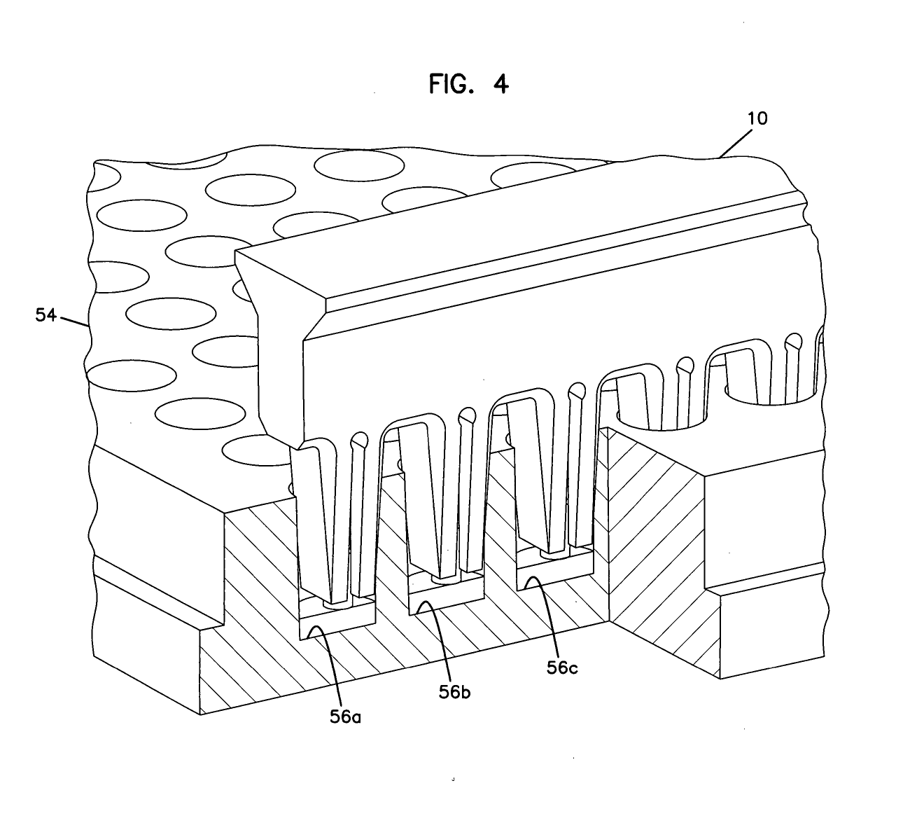

In use, referring to FIGS. 3 and 4, a microtiter plate 54 has a plurality of wells 56 organized into columns 58a-58l with eight wells 56a-56h in each column. Each of the wells contains a liquid sample 60. For example, wells 56a-56c contain samples 60a-60c, respectively. Separate wells 56 may contain the same sample or different samples 60.

Cuvettes 28 are inserted into each of the brackets 16a-16h of the common carrier 10 and positioned so that the bottom of the Cuvette 28 rests against the seat 26. The common carrier 10 is then inverted or turned upside down so that the openings of the Cuvettes 28 are facing downward. The inverted common carrier 10 is positioned over a column 58 of the microtiter plate 54 and lowered until each of the Cuvettes 28 enters a separate well 58a-58h in the column 58 of the microtiter plate 54. The Cuvettes 28 are positioned so that the opening of each of the Cuvettes 28 is simultaneously in contact with the sample in the well 58a-58h, either touching the surface of the sample or positioned below the surface of the sample. The sample in each well 58a-58h then flows into its respective Cuvette 28 by capillary action.

The common carrier 10 can be handled in a variety of ways when loading the Cuvettes 28 with samples and loading the common carrier 10 and Cuvettes 28 into a spectrophotometer. In one possible embodiment, for example, the Cuvettes 28 are manually loaded with sample and the common carrier 10 is manually inserted into the analytically instrument and secured to a carriage by the clamping mechanism 46. In another possible embodiment, a robotic arm 46 is used to maneuver the common carrier when loading the Cuvettes 28 with sample, loading the common carrier 10 and Cuvettes 28 into the spectrophotometer, and or indexing the common carrier within the spectrophotometer. In yet another embodiment, the Cuvettes 28 are manually loaded with sample and then the common carrier 10 is automatically loaded into and indexed through the spectrophotometer using a robotic arm, conveyor system, or other automated mechanism.

After the common carrier 10 and Cuvettes 28 are loaded in to the spectrophotometer, the common carrier 10 is indexed through the spectrophotometer so that each gap 20 and Cuvette 28 is sequentially aligned with the light source and optics of the spectrometer for analysis of the sample loaded in the Cuvette 28. Although the common carrier 10 is disclosed as being used with a spectrophotometer, it can be used with other analytical instruments as well.

Although the exemplary embodiment illustrates eight wells 56A-56h in a column of the microtiter plate 54 and eight brackets 16a-16h on the common carrier 10, other embodiments are possible. In one possible embodiment, for example, the common carrier 10 has the same number of brackets 16 as the number of wells 56 of the microtiter plate 54 with which it is being used. In this embodiment, the number of brackets 16 and the number of wells 56 in a column 58 of the microtiter plate can 54 be eight, ten, twelve, sixteen, etc. In another embodiment, the number of brackets 16 on the common carrier 10 is less than and a factor of (i.e., evenly divisible into) the number of wells 56 in a column 58 of the microtiter plate 54. For example, if there are four brackets 16 on the common carrier 10, there are four, eight, or twelve, etc. wells 56 in a column 58 of the microtiter plate 54.

In another possible embodiment, Cuvettes 18 are loaded into only a portion of the brackets 16. In yet another possible embodiment, Cuvettes 28 of different sizes (e.g., volume) are loaded into brackets 16 on a single common carrier 10. When this embodiment is used, care is take to ensure that the opening of all of the Cuvettes 28 are placed in contact with or below the surface of the samples in microtiter plate wells 56.

After analysis of the samples loaded in the Cuvettes 28 is complete, the Cuvettes 28 are typically discarded. Alternately, the Cuvettes 28 can be cleaned. For example, the Cuvettes 28 can be rinsed with Isopropanol alcohol, then rinsed with water, and then dried with a nitrogen air gun. The common carrier 10 is also cleaned after use to prevent contamination of samples in later testing. In yet another possible embodiment, the Cuvettes 28 are discarded and the common carrier 10 is cleaned for reuse.

### Experiment

An experiment was conducted in which Cuvettes were loaded with sample using the common carrier described herein and using pipettes. Each column (eight wells) in a Falcon 96-well microtiter plate was filled with a total solution volume of 200 μl. The first column was filled with 200 μl of solution formed with water and food color, the second column was filled with 200 μl of solution formed with 30 μg/ml raffinose and food coloring, and the third column was filled 200 μl of solution formed with 100 μg/ml raffinose and food coloring. After loading the common carrier with Cuvettes, it was inverted and dipped into the first column in the microtiter plate. As the Cuvettes contacted the liquid, capillary action filling of the Cuvettes was observed. The common carrier was then turned to an upright position. This procedure was repeated for the second and third columns of the microtiter plate. After each repetition of the procedure, the Cuvettes and common carrier were rinsed with Isopropanol alcohol, rinsed with water, and then dried with a nitrogen air gun until it they were dry.

The observed results for Cuvettes loaded using the common carrier were consistent for the water solution, the 30 μg/ml raffinose solution, and the 100 μg/ml raffinose solution, and included quick uptake of the solution into the Cuvettes, consistent fill levels between all eight Cuvettes held in the common carrier, and an absence of bubbles within the Cuvettes.

The common method of filling Cuvettes by use of a pipette was also performed in the laboratory for the water solution, the 30 ml raffinose solution, and the 100 ml raffinose solution. Each Cuvette was filled with 4 μl of solution. Observed results included uneven filling and the transfer of bubbles from the pipette to the Cuvette. Further, difficulty was encountered in positioning the tip of the pipette into the Cuvette opening.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A method of loading a fluid sample into a capillary vessel, the method comprising:
attaching one or more capillary vessels to a common carrier, each capillary vessel having an opening and an interior volume sized for loading the capillary vessel by capillary action;
positioning the common carrier so that the capillary vessel openings face downward; and
positioning the capillary vessel openings into contact with a fluid in a reservoir.

2. The method of claim 1 further comprising simultaneously loading fluid into the interior volume of the one or more capillary vessels by capillary action.

3. The method of claim 2 wherein the act of attaching one or more capillary vessels to a common carrier includes attaching one or more Cuvettes.

4. The method of claim 3 wherein the act of attaching one or more capillary vessels to a common carrier includes attaching a capillary vessel having an interior volume of about 4 μl or less.

5. The method of claim 3 wherein the act of attaching one or more capillary vessels to a common carrier includes attaching a capillary vessel having an interior volume of about 2 μl.

6. The method of claim 3 wherein the one or more capillary vessels includes at least a first and second capillary vessels, the method further comprising loading the first capillary vessel with a first volume and the second capillary vessel with a second volume.

7. The method of claim 3 wherein the act of positioning the capillary vessel openings into contact with a fluid includes the reservoir consisting of a multi-well plate, wherein each capillary vessel contacts the fluid of one of a different well of the multi-well plate.

8. The method of claim 7 wherein the reservoir consists of a multi-well plate that is structured in columns of wells that are a multiple number of a maximum number of capillary vessels held by the common carrier.

9. The method of claim 8 wherein the reservoir consists of a 96-well plate and the common carrier is able to hold a maximum of 8 capillary vessels.

10. The method of claim 7 further comprising placing the common carrier in an upright position and loading the common carrier into an analytical instrument.

11. The method of claim 10 wherein loading the common carrier into an analytical instrument includes attaching the common carrier to guide.

12. The method of claim 10 wherein loading the common carrier into an analytical instrument includes attaching the common carrier to a clamp.

13. The method of claim 7 further comprising placing the common carrier in an upright position and loading the common carrier into a spectrophotometer.

14. The method of claim 7 further comprising disposing of the common carrier and the capillary vessels.

15. The method of claim 7 further comprising cleaning the common carrier and the capillary vessels.

16. A method of loading a fluid sample, the method comprising:
attaching one or more Cuvettes to a common carrier, each Cuvette having an opening and an interior volume sized for loading the Cuvette by capillary action, the interior volume being about 2 μl or less;
positioning the common carrier so that the Cuvette openings face downward;
positioning the Cuvette openings into contact with a fluid in a reservoir;
simultaneously loading fluid into the interior volume of the one or more Cuvettes by capillary action; and
loading the common carrier into a spectrophotometer.
